(19) United States
(12) Patent Application Publication
(10) Pub. No.: US 2004/0027192 A1
(43) Pub. Date: Feb. 12, 2004

(54) Automatic voltage sense circuit

(76) Inventors: Roger A. Fratti, Cumru Township, PA (US); Elizabeth E. Perry, Muhlenberg Township, PA (US); Dwight D. Daugherty, Ephrata, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/214,533

(22) Filed: Aug. 8, 2002

(51) Int. Cl. G05F 1/10

(52) U.S. Cl. 327/540

(57) ABSTRACT

A voltage sense circuit and method of providing an operating voltage to a low voltage integrated circuit are provided. The voltage sense circuit includes a switch responsive to a control signal. The switch is coupled between an input node and a power supply node, and a voltage drop circuit is coupled in parallel with the switch. The voltage drop circuit is configured to provide the operating voltage at the power supply node when a power supply voltage at the input node is approximately an operating voltage of a higher voltage integrated circuit. The voltage sense circuit also includes a control circuit coupled to the switch. The control circuit is configured to control the switch to substantially pass the power supply voltage to the power supply node when the power supply voltage is approximately the operating voltage of the low voltage integrate circuit.

### FIELD OF THE INVENTION

The present invention relates to integrated circuits, and more particularly to power supply circuitry for integrated circuits.

### BACKGROUND OF THE INVENTION

As device sizes in integrated circuits decrease, high speed technologies are transitioning from higher operating voltages to lower operating voltages. For example, higher speed silicon devices have ever-lowering breakdown voltages and typically can handle only lower operating voltages. Consequently, as new circuits are designed using lower voltage technology generations, they typically cannot handle the supply voltages of the higher voltage, legacy generations.

Oftentimes, circuits spanning two or more voltage generations are used together in a single system. For example, a 3.3 volt integrated circuit (IC) may be next to an older generation 5.0 volt IC. If the end user is limited in the number of available supplies, it is difficult to use a newer generation 3.3 volt IC with the 5.0 volt IC. In a second example, it is likewise difficult to use a 1.5 volt IC along with a 3.3 volt IC. These combinations require two or three supply voltages on the same system, i.e., 1.5 volts, 3.3 volts and 5.0 volts. To resolve this issue, the IC designer or manufacturer could provide additional functionality on the IC that allows operation from different supply voltages. Different pins or pads on the IC may be provided that would each support a different supply voltage. However, there are not always enough pads available to the designer. This is particularly true, for example, for newer generation SiGe products since they typically have much more functionality than current GaAs products.

A second approach is to provide an on-chip voltage regulator. The primary disadvantage of this approach is that the pass transistor must operate in the linear region to maintain stability of the regulator control loop. The non-saturating voltage drop of the pass transistor reduces the available voltage to operate the remaining circuit. The regulator pass transistor needs to maintain at least a 0.2 volt drop at the lowest operating supply voltage of 3.0 volts, if defined as a 3.3+/−10% supply. Therefore the pass transistor will only provide 2.8 volts for the circuit operation. This wasted voltage drop can be detrimental to many of the high performance circuits in terms of headroom, meaning voltage available to the circuit transistors at its operating extremes. As designs transition to the lower supplies of 1.5 volts the 0.2 volt drop across the pass transistor will adversely impact the operation of the IC.

### SUMMARY OF THE INVENTION

A voltage sense circuit is described for providing an operating voltage for a low voltage integrated circuit regardless of whether a high or low voltage power supply voltage is applied. The voltage sense circuit includes a switch responsive to a control signal. The switch is coupled between an input node and a power supply node, and a voltage drop circuit is coupled in parallel with the switch. The voltage drop circuit is configured to provide the operating voltage at the power supply node when a power supply voltage at the input node is approximately an operating voltage of a higher voltage integrated circuit. The voltage sense circuit also includes a control circuit coupled to the switch. The control circuit is configured to control the switch to substantially pass the power supply voltage to the power supply node when the power supply voltage is approximately the operating voltage for the low voltage integrated circuit. An integrated circuit and integrated circuit chip including the voltage sense circuit are also provided.

A method of providing an operating voltage to a low voltage integrated circuit is provided. A power supply voltage is received at a bond pad input. The power supply voltage is substantially coupled to a power supply node of the integrated circuit if the power supply voltage is approximately equal to the operating voltage of the low voltage integrated circuit. A portion of the power supply voltage approximately equal to the operating voltage of the low voltage integrated circuit is coupled to the power supply node if the power supply voltage is approximately equal to an operating voltage of a high voltage integrated circuit.

The system and method allow a single power supply bond pad or pin to accept both a high voltage generation operating voltage and a low voltage generation operating voltage. This in turn frees pad inputs for design of increased functionality, while eliminating the need to offer additional parts for different supply voltages. In addition, the use of a saturated pass transistor as a switch allows extremely low voltage insertion loss for circuits that would be capable of handling the larger voltage drops of traditional linear regulators. Further, the method and system avoid stability issues associated with closed loop amplifiers of traditional linear regulators. Also, the system and method are described herein in terms of a bi-state switch, but could easily be extended to accommodate more than two voltage states. The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is a block diagram of an integrated circuit system including a voltage sense circuit;

FIGS. 2 and 2A are block diagrams illustrating various components of the system of FIG. 1; and

FIGS. 3-5 are graphs illustrating the function of the system of FIGS. 1-2A.

### DETAILED DESCRIPTION

The voltage sense circuit provided herein is described in terms of an operating voltage of 5.0 volts for a higher voltage integrated circuit (sometimes referred to herein as high operating voltage generation integrated circuit) and 3.3 volts for an operating voltage for a low voltage integrated circuit (sometimes referred to herein as low operating voltage generation integrated circuit), however, the present invention is by no means limited to these values or integrated circuit generations. These values are provided as examples, and one of ordinary skill should recognize that the circuit approach and method of providing an operating voltage to a low operating voltage generation integrated circuit applies to other operating voltage combinations. For example, a 3.3 volt generation may be considered a high operating voltage generation vis-a-vis a 1.5 volt integrated circuit.

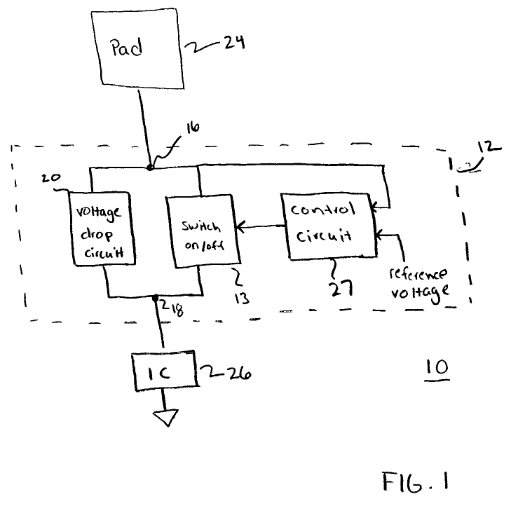

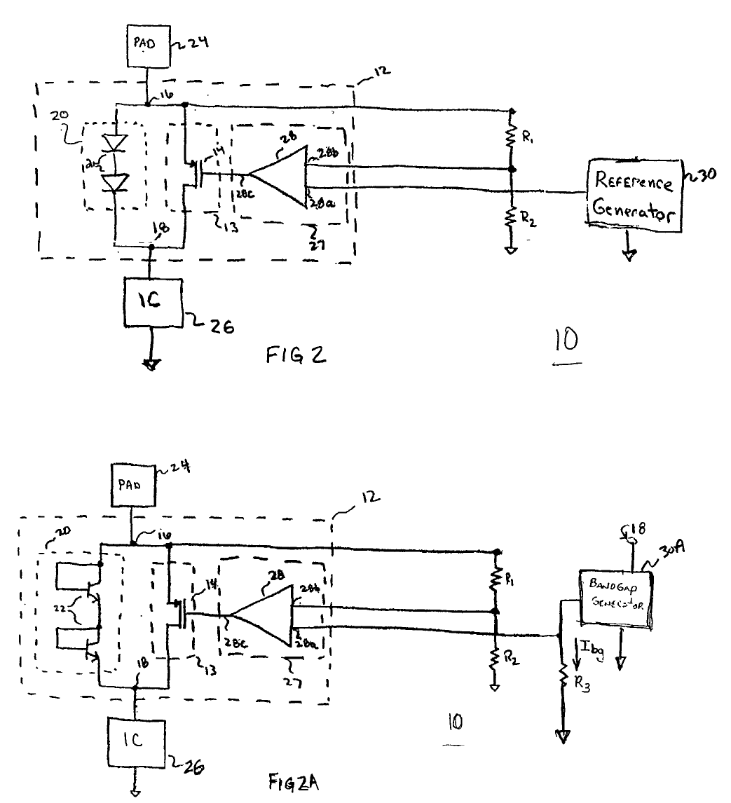

Referring first to FIGS. 1, 2 and 2A, block diagrams of an integrated circuit system 10 are provided. The system 10 includes a low voltage integrated circuit 26 designed to operate at a low operating voltage (Vcc) such as 3.3 volts. Integrated circuits operating at 3.3 volts typically have an operating range of 3.3 volts±10%, approximately 3-3.6 volts. This operating voltage is provided at integrated circuit power supply node 18. Examples of such integrated circuits 26 include amplifier circuits, retiming circuits, electro-absorption modulator drivers included in, for example, optoelectronic transmitters and receivers.

A voltage sense circuit 12 is coupled between integrated circuit 26 and bond pad 24. Bond pad 24 is coupled to a power supply voltage of either a higher operating voltage (e.g., 5.0 volts A±5%- between approximately 4.75-5.25 volts) or a low operating voltage (e.g., 3.3 volts A ±10%—between approximately 3.0-3.6 volts), depending upon which operating voltage supply is available. Coupled between input node 16 and power supply node 18 are voltage drop circuit 20 and switch 13 of voltage sense circuit 12. Voltage drop circuit 20 provides a voltage drop from the expected high voltage operating voltage (4.75-5.25 volts) to the low operating voltage needed by the integrated circuit 26. For example, assuming a nominal high operating voltage of 5.0 volts and a nominal low operating voltage of 3.3 volts, voltage drop circuit 20 is designed to drop approximately 1.7 volts between input node 16 and power supply node 18. This may be accomplished by, for example, one or more diodes sized to provide the desired voltage drop. These diodes are shown as, for example, a pair of npn bipolar junction transistors 22 in FIG. 2A, each designed to have a base-to-emitter (V_{BE}) voltage drop of 0.85 volts. An alternative to the bipolar transistors is a pair of schottky diodes 21, as shown in FIG. 2.

As mentioned, disposed in parallel with the voltage drop circuit 20 is switch 13. Switch 13 preferably includes a MOS transistor, and in one embodiment a PMOS transistor 14 as shown in FIGS. 2 and 2A. PMOS transistor 14 has a gate terminal coupled to an output of control circuit 27. PMOS transistor 14 is triggered by a control signal from the control circuit 27. When a low signal, such as 0.0 volts, is provided to the gate terminal of PMOS transistor 14, the transistor switches “on” into a saturated region, thereby connecting the power supply voltage at input node 16 to power supply node 18 through transistor 14 and effectively shunting out voltage drop circuit 20. When a high signal, such as the supply voltage, is provided to the gate terminal by the control circuit 27, the PMOS transistor 14 remains “off”, thereby disconnecting node 16 and node 18 through transistor 14. Transistor 14 may alternatively be embodied as a micromechanical switch or off-chip MOS switch.

Using the example of possible nominal operating voltages of 5.0 volts and 3.3 volts, if 3.3 volts is presented to node 16 via bond pad 24, control circuit 27 provides a low signal to the gate terminal of PMOS transistor 14, turning PMOS transistor 14 “on” and passing the voltage at node 16 to node 18. The voltage at node 16 is substantially passed to node 18 when the PMOS transistor is driven in the saturation region where the PMOS transistor 14 realizes only a minimal voltage drop of less than approximately 25-50 mV. The control circuit 27 is designed to place PMOS device into its saturated region by providing an appropriately negative VGS voltage on node 28c, as required for the characteristic of that particular PMOS device. When the PMOS transistor 14 is “on”, and thus the switch 13 is closed, the voltage drop circuit 20 is effectively shunted out or bypassed. If 5 volts is applied to input node 16 via bond pad 24, then control circuit 27 provides a high signal to the gate terminal of the PMOS transistor 14, thereby turning PMOS transistor “off” and opening the switch 13. Voltage drop circuit 20 then drops the desired (and designed) voltage drop of 1.7 volts between input node 16 and power supply node 18, realizing 3.3 volts at node 18. In this manner, regardless of whether a high operating voltage (such as for a legacy generation) or low operating voltage (such as is appropriate for low voltage integrated circuit 26) is provided at bond pad 24, integrated circuit 26 receives an appropriate low operating voltage at power supply node 18.

Control circuit 27 is now described. Control circuit 27 provides the aforementioned control signal to switch 13 responsive to the value of the voltage at input node 16 as received at bond pad 24 in order to open and close switch 13. Control circuit 27 may be implemented using a comparator 28 having output 28c coupled to the gate terminal of PMOS transistor 14. A constant power supply independent reference voltage, such as 1 volt, is provided at a first input 28a of comparator 28. A power supply voltage dependent voltage is then provided to a second input 28b through a voltage divider shown including resistors R₁ and R₂ in FIGS. 2 and 2A. Assuming that the nominal high operating voltage is 5 volts and the nominal low operating voltage is 3.3 volts, a switching point may be chosen halfway between the high and low operating voltages, i.e., at 4.15 volts. Again, assuming that the reference voltage at input 28a is a relatively constant 1 volt, then resistance values for R₁ and R₂ are selected so that 1 volt is present at second input 28b at approximately the halfway voltage between the high and low operating voltages 4.15 volts. This provides a switching point for the comparator 28 when the power supply voltage is approximately 4.15 volts. If resistor R₁, is designed to have, for example, a value of 9.45 kΩ, then resistor R₂ is designed to have a value of approximately 3 kΩ, by utilizing the voltage divider equation ((R₂+μl)/R₂), provides a voltage divider ratio of 4.15:1. If the supply voltage is greater than 4.15 volts, then a voltage at second input 28b exceeds the power supply independent 1 volt reference voltage. In response thereto, comparator 28 provides a high output signal at output 28c, insuring that PMOS transistor 14 is “off” as described above. If the supply voltage is less than 4.15 volts, then a voltage at second input 28b is less than the power supply independent 1 volt reference voltage. In response thereto, comparator 28 provides a low output signal at output 28c, insuring that PMOS transistor 14 is “on” as described above.

In operation, the expected high and low operating voltages for the 5.0 and 3.3 nominal operating voltages are range-limited to 4.75-5.25 volts and 3.0-3.6 volts, respectively. Consequently, even though the switching point is selected at 4.15 volts—halfway between the nominal high and low operating voltages—this value is not expected and ambiguity at second input 28b as to whether a high or low operating voltage is provided at input node 16 is avoided. Put another way, even if the lowest expected value for the high operating voltage range is received at input node 16, i.e., 4.75 volts, second input 28b sees approximately 1.15 volts, which is sufficient to allow comparator 28 to clearly recognize a voltage value greater than the 1 volt reference voltage at first input 28a. Conversely, if the highest expected value for the low operating voltage is received at input node 16, i.e., 3.6 volts, second input 28b sees approximately 0.87 volt, which is sufficient to allow comparator 28 to clearly recognize a voltage value less than the 1 volt reference voltage at first input 28a. Of course, the selection of the reference voltage value and the resistance ratio for resistors R₁ and R₂ may be selected to accommodate the tolerance of the comparator 28 and/ or vice versa.

From the above, it should be clear that a relatively constant—meaning substantially power supply independent—reference voltage is desirable. Numerous approaches are available for providing constant reference voltages. In one embodiment shown in FIG. 2, a reference generator 30, the details of which are familiar to those of ordinary skill and are not repeated herein except as follows, provides this reference voltage. One example of a reference generator 30 is shown in FIG. 2A. Most commercial integrated circuits designs have built-in bandgap generators 30A (FIG. 2A) for providing reference voltages. The bandgap generator 30A typically includes at least one current mirror for providing a relatively constant reference voltage. Bandgap generator 30A of FIG. 2A, whose supply voltage is shown derived from the voltage at PAD 24, provides a constant current I_{BG} of, for example, 100 μA through resistor R₃, which may be 10 kΩ, in order to provide a constant 1 volt reference voltage at first input 28a. Internal to the bangap generator 30A is an internally generated reference voltage (not shown) that is constant with respect to the supply voltage. This reference is used to generate the constant current, which is mirrored to develop the scaled 100 μA source current.

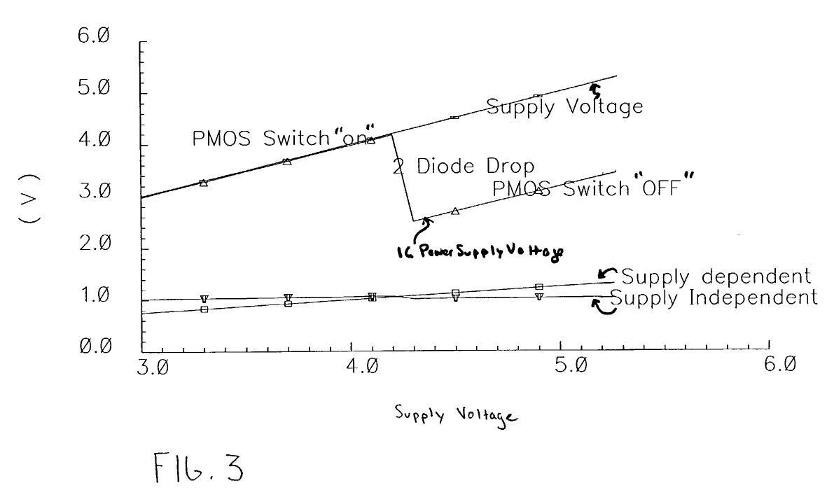

FIGS. 3-5 are graphs illustrating results of a simulation of the present integrated circuit system 10. Referring first to FIG. 3, various voltages are plotted against the supply voltage at node 16. The reference voltage, labeled as “Supply Independent,” at comparator first input 28a is shown. The reference voltage has a relatively constant voltage value of 1 volt, although it does indicate some voltage dependence. Even an imperfect bandgap bias generator is suitable for purposes of generating a reference voltage, as long as the reference voltage is desensitized to the power supply voltage and behaves in a monotonic relationship to the power supply voltage. The supply dependent voltage—the voltage at second comparator input 28b—increases linearly, as expected, as the supply voltage increases over the range from 3 volts (the low voltage of the low operating voltage range) to approximately 5.25 volts (the high voltage of the high operating voltage range). The supply voltage is also plotted against itself for purposes of comparison with the integrated circuit power supply voltage at power supply node 16. As can be seen from the graph of FIG. 3, the IC power supply voltage follows the power supply voltage when the PMOS switch is “on” through the low voltage operating range of 3.0-3.6 volts and indeed up to the expected switching point of approximately 4.15 volts. When the PMOS transistor 14 switches “off”, the voltage drop circuit 20 operates to provide the voltage drop between input node 16 and power supply node 18. The graph indicates that in the high operating voltage supply range of between approximately 4.75-5.25 volts, the voltage drop brings the IC power supply voltage at node 18 within the acceptable low operating voltage range, i.e., within approximately 3.0-3.6 volts.

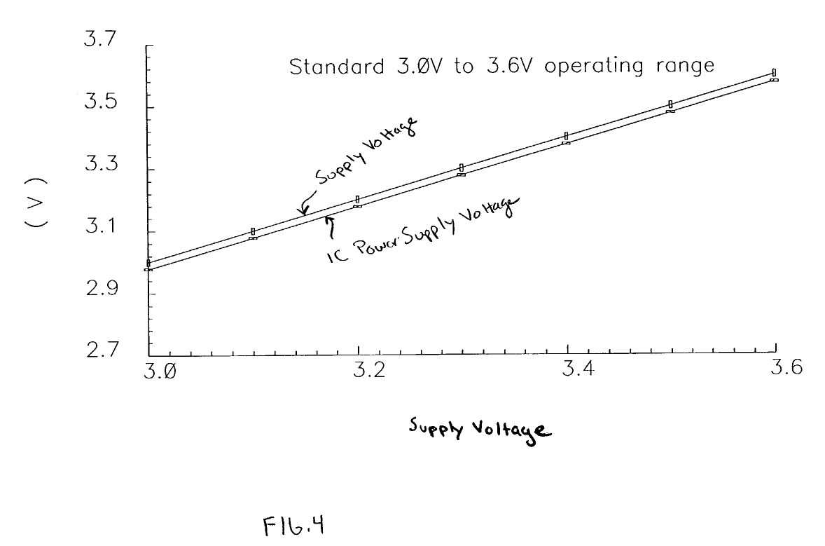

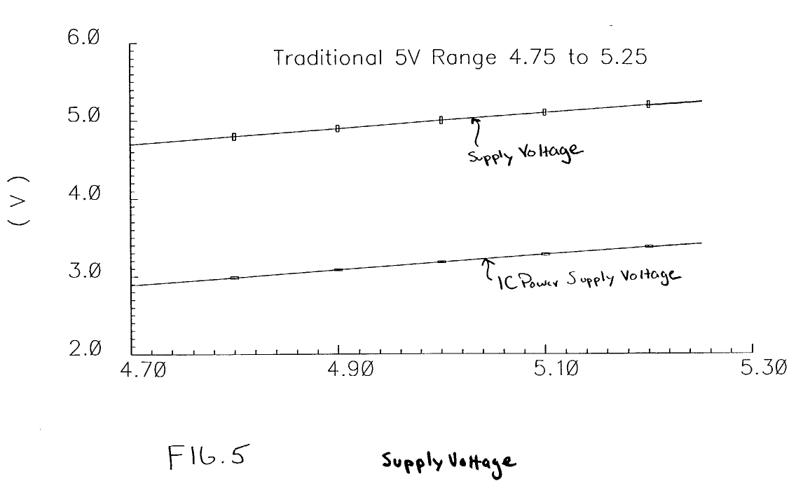

FIGS. 4-5 further illustrate the above results. Referring first to FIG. 4, an enlarged view of the low operating voltage range of 3.0-3.6 volts is shown—the range where the PMOS transistor 14 is expected to be “on”. Both the supply voltage at node 16 and the IC power supply voltage at node 18 are shown. It can be seen that the IC power supply voltage substantially tracks the power supply voltage. Put another way, the power supply voltage is substantially passed through the switch 13 to the IC power supply node 18, except for a minimal voltage drop of approximately 0.25 mV across the PMOS transistor 14, which operates in the saturated region.

FIG. 5 illustrates the operation of the voltage sense circuit 12 over the high operating voltage range of 4.75-5.25 volts. As can be seen over this range, where the PMOS transistor is “off”, the voltage drop circuit 20, and specifically diodes 22, drops sufficient voltage between input node 16 and IC power supply node 18 to translate the high operating power supply voltage to a low operating voltage range appropriate for a low operating voltage integrated circuit 26.

Also provided in this description is a method of providing an operating voltage to a low voltage generation integrated circuit. A power supply voltage is received at a bond pad input. The power supply voltage is substantially coupled to a power supply node of the low voltage generation integrated circuit if the power supply voltage is approximately equal to a low voltage generation operating voltage, i.e., the operating voltage range for the low voltage generation integrated circuit. If the power supply voltage is approximately equal to a high voltage generation operating voltage, i.e., the operating voltage range for the higher voltage generation integrated circuit, a portion of the power supply voltage approximately equal to the low voltage generation operating voltage is coupled to the power supply node.

The voltage sense circuit 12 of the present invention is preferably incorporate into an integrated circuit design and included within an IC chip. However, it is contemplated that the voltage sense circuit 12, or components therein, such as the control circuit 27, switch 13 and/or voltage drop circuit 20, may be provided external to the integrated circuit and integrated circuit chip. It should also be understood that integrated circuit system 10 may be combined with other integrated circuits to provide desired functionality. These integrated circuits are then packaged to form chips and may be mounted, for example, on a printed circuit board.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention

What is claimed is:

1. A voltage sense circuit for providing an operating voltage for a low voltage integrated circuit, comprising:
a switch responsive to a control signal, said switch coupled between an input node and a power supply node;
a voltage drop circuit coupled in parallel with said switch, said voltage drop circuit configured to provide said operating voltage at said power supply node when a power supply voltage at said input node is approximately an operating voltage of a higher voltage integrated circuit; and
a control circuit coupled to said switch, said control circuit configured to control said switch to substantially pass said power supply voltage to said power supply node when said power supply voltage is approximately said operating voltage of said low voltage integrated circuit.

2. The voltage sense circuit of claim 1, wherein said switch includes a MOS transistor having a gate terminal coupled to an output of said control circuit.

3. The voltage sense circuit of claim 2, wherein said MOS transistor is a PMOS transistor that operates in saturation mode when passing said power supply voltage.

4. The voltage sense circuit of claim 1, wherein said voltage drop circuit includes at least one diode sized to provide a voltage drop from said operating voltage of said higher voltage integrated circuit to said operating voltage of the low voltage integrated circuit.

5. The voltage sense circuit of claim 4, wherein said voltage drop circuit includes a plurality of bipolar junction transistors coupled to provide said voltage drop.

6. The voltage sense circuit of claim 1, wherein said control circuit includes a comparator coupled to provide said control signal in response to a power supply independent reference voltage and a power supply dependent reference voltage.

7. The voltage sense circuit of claim 6, further comprising a bandgap reference circuit for providing said reference voltage.

8. The voltage sense circuit of claim 7, wherein said bandgap reference circuit includes at least one current mirror.

9. An integrated circuit chip, comprising:
a low voltage integrated circuit coupled to a power supply node;
a bond pad input; and
a voltage sense circuit, comprising:
a switch responsive to a control signal, said switch coupled between said bond pad input and said power supply node;
a voltage drop circuit coupled in parallel with said switch, said voltage drop circuit configured to provide an operating voltage of the low voltage integrated circuit at said power supply node when a power supply voltage at said bond pad input is approximately an operating voltage of a higher voltage integrated circuit; and
a control circuit coupled to said switch, said control circuit configured to control said switch to substantially pass said power supply voltage to said power supply node when said power supply voltage is approximately the operating voltage of said low voltage integrated circuit.

10. The integrated circuit chip of claim 9, wherein said switch includes a MOS transistor having a gate terminal coupled to an output of said control circuit.

11. The integrated circuit chip of claim 10, wherein said MOS transistor is a PMOS transistor that operates in saturation mode when passing said power supply voltage.

12. The integrated circuit chip of claim 9, wherein said voltage drop circuit includes at least one diode sized to provide a voltage drop from said operating voltage of said higher voltage integrated circuit to said operating voltage of the low voltage integrated circuit.

13. The integrated circuit chip of claim 12, wherein said voltage drop circuit includes a plurality of bipolar junction transistors coupled to provide said voltage drop.

14. The integrated circuit chip of claim 9, wherein said control circuit includes a comparator coupled to provide said control signal in response to a power supply voltage independent reference voltage and a power supply voltage dependent voltage.

15. The integrated circuit chip of claim 14, further comprising a bandgap reference circuit for providing said reference voltage.

16. The integrated circuit chip of claim 15, wherein said bandgap reference circuit includes at least one current mirror.

17. A method of providing an operating voltage to a low voltage integrated circuit, comprising the steps of:
(a) receiving a power supply voltage at a bond pad input;
(b) coupling said power supply voltage substantially to a power supply node of said integrated circuit if said power supply voltage is approximately equal to the operating voltage of the low voltage integrated circuit; and
(c) coupling a portion of said power supply voltage approximately equal to said operating voltage of the low voltage integrated circuit to said power supply node if said power supply voltage is approximately equal to an operating voltage of a higher voltage integrated circuit.

18. The method of claim 17, wherein coupling step (b) includes the step of controlling a switch to couple said power supply voltage to said power supply node responsive to said power supply voltage.

19. The method of claim 18, wherein coupling step (b) includes the step of driving a MOS transistor to operate in saturation mode.

20. The method of claim 17, wherein coupling step (c) includes the step of dropping at least a portion of said power supply voltage across a diode series.

21. The method of claim 17, wherein said coupling steps includes the steps of controlling a switch to selectively couple said power supply node to said power supply voltage in response to a comparison of a power supply voltage independent reference voltage and a power supply voltage dependent voltage.

22. An integrated circuit chip, comprising:
a low voltage integrated circuit coupled to a power supply node;
a bond pad input; and
a voltage sense circuit, comprising:
a switch including a MOS transistor coupled between said bond pad input and said power supply node and having a gate terminal coupled to receive a control signal for triggering said switch to substantially pass a power supply voltage at said bond pad input to said power supply node when said power supply voltage is approximately an operating voltage of the low voltage integrated circuit;
a voltage drop circuit coupled in parallel with said switch, said voltage drop circuit including at least one diode sized to provide a voltage drop from an operating voltage of a higher voltage integrated circuit to said operating voltage of the low voltage integrated circuit; and
a control circuit including a comparator having an output coupled to said switch, said comparitor coupled to provide said control signal responsive to a power supply voltage dependent voltage and a power supply voltage independent reference voltage.

23. The integrated circuit chip of claim 22, wherein said MOS transistor is a PMOS transistor configured to operate in saturation mode when passing said power supply voltage.

24. The integrated circuit chip of claim 22, wherein said voltage drop circuit includes a plurality of bipolar junction transistors coupled to provide said voltage drop.

25. The integrated circuit chip of claim 22, further comprising a bandgap reference circuit for providing said reference voltage.
